(19) United States
(12) Patent Application Publication
(10) Pub. No.: US 2005/0010870 A1
(43) Pub. Date: Jan. 13, 2005

(54) Post-processing algorithm for byte-level file differencing

(76) Inventors: Jinsheng Gu, Alviso, CA (US); Liwei Ren, Alviso, CA (US)

Correspondence Address: Shemwell Gregory & Courtney LLP, Suite 201, 4880 Stevens Creek Boulevard, San Jose, CA, 95129, US

(21) Appl. No.: 10/616,681

(22) Filed: Jul. 9, 2003

(51) Int. Cl. G06F 15/00

(52) U.S. Cl. 715/540

(57) ABSTRACT

Devices and methods are provided for generating difference files that include encoded differences between byte streams of original and new file versions. Generation of the difference files includes processing by components of an optimizing system and/or algorithm to identify replacement content in a first area of the new byte stream. The replacement content includes a group of bytes of the new byte stream identified as at least one of byte insertions and byte replacements in a corresponding operation array. The optimizing system identifies content similarities between the replacement content and at least one of the original byte stream and a second area of the new byte stream. The optimizing system generates information of the difference file by encoding information of the content similarities.

### RELATED APPLICATION

This application relates to U.S. patent application Ser. No. 10/146,545, filed May 13, 2002, U.S. patent application Ser. No. (not yet assigned; application titled PROCESSING SOFTWARE IMAGES FOR USE IN GENERATING DIFFERENCE FILES, Attorney Docket Number DOGO.P011), filed Jun. 20, 2003; and U.S. patent application Ser. No. (not yet assigned; application titled FILE DIFFERENCING AND UPDATING ENGINES, Attorney Docket Number DOGO.P012), filed Jul. 9, 2003.

### TECHNICAL FIELD

The disclosed embodiments relate to updating of electronic files using difference files.

### BACKGROUND

Software running on a processor, microprocessor, and/or processing unit to provide certain functionality often changes over time. The changes can result from the need to correct bugs, or errors, in the software files, adapt to evolving technologies, or add new features, to name a few. In particular, embedded software components hosted on mobile processing devices, for example mobile wireless devices, often include numerous software bugs that require correction. Software includes one or more files in the form of human-readable American Standard Code for Information Interchange (ASCII) plain text files or binary code. Software files can be divided into smaller units that are often referred to as modules or components.

Portable processor-based devices like mobile processing devices typically include a real-time operating system (RTOS) in which all software components of the device are linked as a single large file. Further, no file system support is typically provided in these mobile wireless devices. In addition, the single large file needs to be preloaded, or embedded, into the device using a slow communication link like a radio, infrared, or serial link.

Obstacles to updating the large files of mobile processing devices via slow communication links include the time, bandwidth, and cost associated with delivering the updated file to the device. One existing solution to the problem of delivering large files to mobile processing devices includes the use of compression. While a number of existing compression algorithms are commonly used, often, however, even the compressed file is too large for download to a device via a slow, costly, narrowband communication link.

Another typical solution for updating files uses difference programs to generate a description of how a revised file differs from an original file. There are available difference programs that produce such difference data. However, as with compression, the difference files produced using these difference programs can sometimes be too large for transfer via the associated communication protocols.

### BRIEF DESCRIPTION OF THE FIGURES

FIG. 1 is a block diagram showing a file differencing and updating system, under an embodiment.

FIG. 2 is a block diagram of a file differencing engine, under the embodiment of FIG. 1.

FIG. 3 is a flow diagram for generation of a delta file, under the embodiment of FIG. 1 and FIG. 2.

FIG. 4 is a flow diagram for optimizing a delta file, under the embodiment of FIG. 2 and FIG. 3.

FIG. 5 is an example segment of an operation array that codes information of a new file as insertion of new data instead of movement of data of the original file, under an embodiment.

FIG. 6 is an example segment of an operation array that codes information of a new file as replacement of new data instead of exchanges of data among locations in the original file, under an embodiment.

FIG. 7 is an example segment of an operation array that codes information of a new file as insertion of new data instead of movement of data of the original file followed by a replacement of data, under an embodiment.

FIG. 8 is an example segment of an operation array that codes information of a new file as replacement of new data instead of exchanges of data among locations in the original file followed by a replacement of data, under an embodiment.

FIG. 9 is a block diagram for use in identifying content similarity between replacement content nᵣ and known content n_{known} of the new byte stream, under the embodiment of FIG. 4.

FIG. 10 is a block diagram for use in identifying content similarity between replacement content nᵣ of a new byte stream and local content o_{local} of a corresponding original byte stream, under the embodiment of FIG. 4.

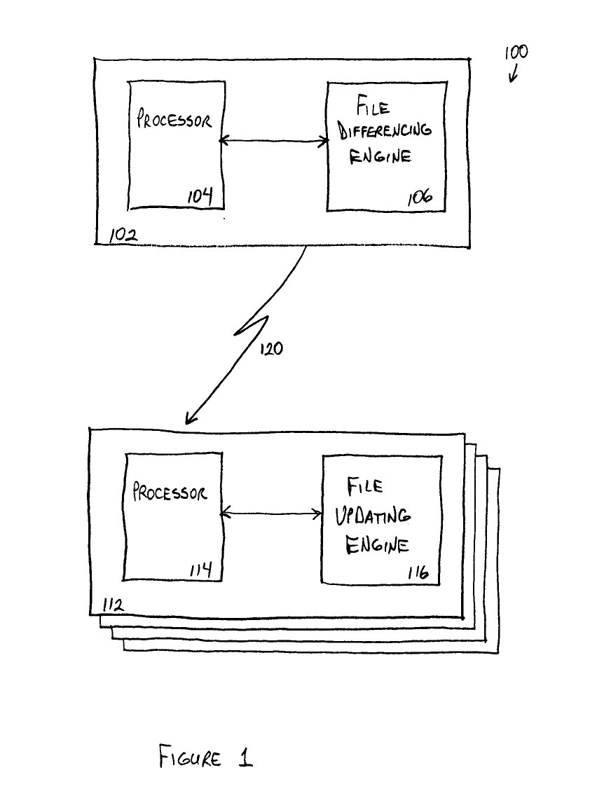

In the drawings, the same reference numbers identify identical or substantially similar elements or acts. To easily identify the discussion of any particular element or act, the most significant digit or digits in a reference number refer to the Figure number in which that element is first introduced (e.g., element 124 is first introduced and discussed with respect to FIG. 1).

### DETAILED DESCRIPTION

Devices and methods for generating difference files between two versions of an electronic file, herein referred to as file differencing, are described in detail herein. Generation of the difference files includes processing by components of an optimizing system and/or algorithm to identify replacement content in a first area of the new byte stream. The replacement content includes a group of bytes of the new byte stream identified as at least one of byte insertions and byte replacements in a corresponding operation array. The optimizing system identifies content similarities between the replacement content and at least one of the original byte stream and a second area of the new byte stream. The optimizing system generates information of the difference file by encoding information of the content similarities.

FIG. 1 is a block diagram showing a file differencing and updating system 100, under an embodiment. Generally, the file differencing and updating system includes a file differencing component and a file updating component. The differencing component, referred to herein as the file differencing engine, or differencing engine, generates a difference file in a first processor-based or computer system from an original or old version and a new version of an electronic file. The updating component, referred to herein as the file updating engine, or updating engine, generates a copy of the new file on a second processor-based or computer system using the difference file and the hosted copy of the original file.

In the following description, numerous specific details are introduced to provide a thorough understanding of, and enabling description for, embodiments of the invention. One skilled in the relevant art, however, will recognize that the invention can be practiced without one or more of the specific details, or with other components, systems, etc. In other instances, well-known structures or operations are not shown, or are not described in detail, to avoid obscuring aspects of the invention.

With reference to FIG. 1, a first computer system 102 and a second computer system 112 communicate via a communication path 120. These computer systems 102 and 112 include any collection of computing components and devices operating together, as is known in the art. The computer systems 102 and 112 can also be components or subsystems within a larger computer system or network.

The first computer system includes at least one processor 104 coupled to at least one file differencing engine 106, described in detail below. The processor 104 and file differencing engine 106 can also be coupled among any number of components (not shown) known in the art, for example buses, controllers, memory devices, and data input/output (I/O) devices, in any number of combinations.

The second computer system includes at least one processor 114 coupled to at least one file updating engine 116, described in detail below. The processor 114 and file updating engine 116 can also be coupled among any number of components (not shown) known in the art, for example buses, controllers, memory devices, and data input/output (I/O) devices, in any number of combinations. The file differencing engine 106 and the file updating engine 116 form the file differencing and updating system 100.

The communication path 120 includes any medium by which files are communicated or transferred between the computer systems 102 and 112. Therefore, this path 120 includes wireless connections, wired connections, and hybrid wireless/wired 15. connections. The communication path 120 also includes couplings or connections to networks including local area networks (LANs), metropolitan area networks (MANs), wide area networks (WANs), proprietary networks, interoffice or backend networks, and the Internet. Furthermore, the communication path 120 includes removable fixed mediums like floppy disks, hard disk drives, and CD-ROM disks, as well as telephone lines, buses, and electronic mail messages.

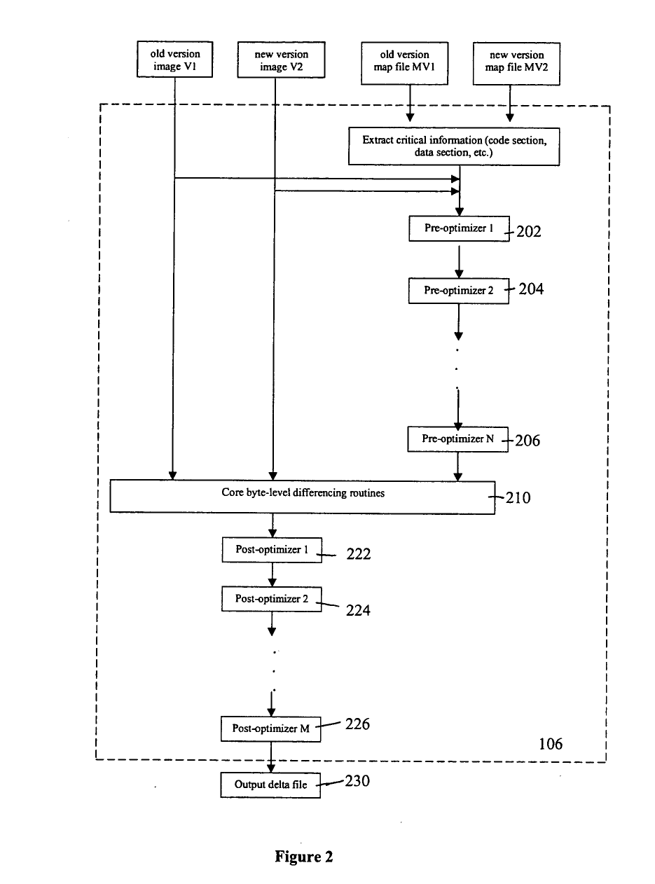

FIG. 2 is a block diagram of a file differencing engine 106, under the embodiment of FIG. 1. Generally, and with reference to FIGS. 1 and 2, the first communication system 102 receives an original version V1 and a new version V2 of an electronic file. The original version V1 also may be referred to as the old version. The new version V2 is generally an updated or revised version of the original version V1, but is not so limited. The electronic files V1 and V2 include software files including dynamic link library files, shared object files, embedded software components (EBSCs), firmware files, executable files, data files including hex data files, system configuration files, and files including personal use data, but are not so limited. The map files MV1 and MV2 corresponding to the original V1 and new V2 versions are also received. The map files include high-level text files that include the start address and size of each symbol of a corresponding software image, with symbol examples including function and global variables. The map files are output by compiler/linker utilities, and are also known as log files, symbol files, and/or list files.

Components of the file differencing engine 106 receive the new version V2, compare it to the original version V1, and calculate the differences between the compared files, as described below. These differences include byte-level differences between the compared files, but are not so limited. The file differencing engine 106 of an embodiment generates and outputs a difference file 230, also referred to as a delta file 230, during the comparison.

The components of the file differencing engine 106 of an embodiment include at least one pre-optimizer system 202-206, at least one differencing system 210, and at least one post-optimizer system 222-226, as described in the Related Applications. The pre-optimizer systems 202-206, differencing systems 210, and post-optimizer systems 222-226 include at least one processor running under control of at least one pre-optimizer, differencing, and post-optimizer algorithm, program, or routine, respectively.

Contents of the delta file 230 provide an efficient representation of the differences between the new version V2 and the original version V1. The delta file 230 includes meta-data along with actual data of replacement and/or insertion operations that represent the differences between the new or current version of the associated file and previous versions of the file, as described in the Related Applications, but is not so limited.

The differences between an original file and a new file are typically smaller than the new file, leading to significant storage and transmission savings if the differences are transmitted and stored instead of the entire new file. This is particularly important for mobile electronic devices (client devices) hosting programs that are updated via connections that typically can be slow and expensive, for example wireless or cellular connections. The reduced size of the delta file provides numerous improvements, one of which includes a reduction in bandwidth required for transmission of the delta file to the client device; the smaller file means less bandwidth is required for the transfer. Also, smaller files require less time for transmission and, therefore, decrease the probability that the file transfer will be interrupted and simultaneously reduce transmission errors in the received file. In addition, it is safer to transmit the delta files than the new software images via a non-secure connection. All of these improvements increase customer satisfaction.

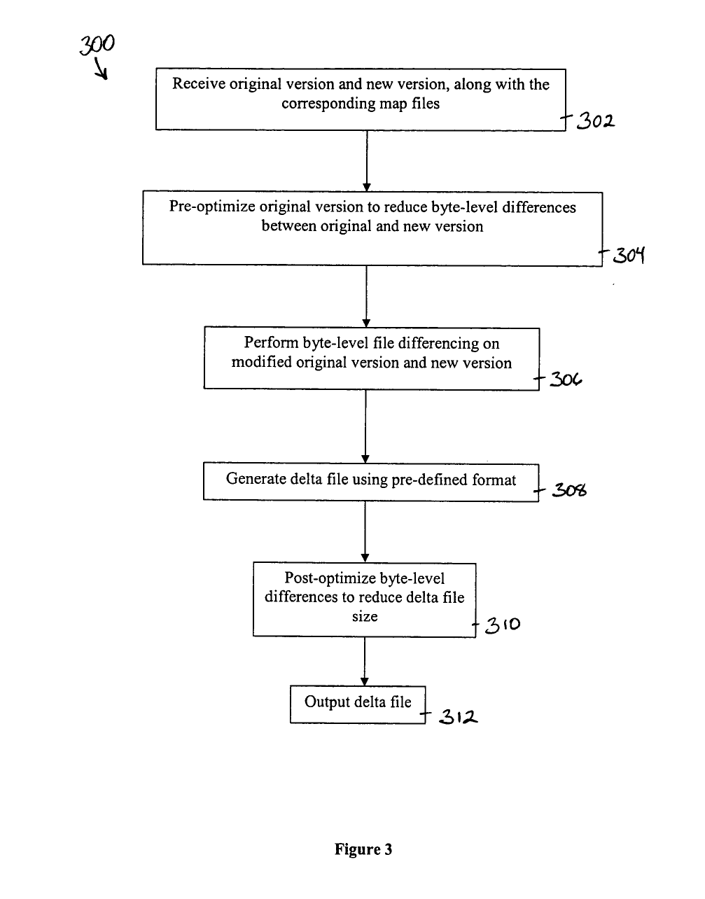

FIG. 3 is a flow diagram 300 for generation of a delta file, under the embodiment of FIG. 1 and FIG. 2. With further reference to FIG. 2, operation begins when a new file and an original file are received in a first computer system, at block 302. The map files corresponding to the new and original files are also received, and information is extracted from the map files. Pre-optimizing operations are performed on the original version in order to reduce differences between the original and new versions, for example byte-level differences, at block 304. Generally, the pre-optimizing uses identified common segments and patterns to reduce/remove pre-specified changes between the new and original files, as described in the Related Applications. Thus, this pre-optimizing reduces the differences among common segments of the files, thereby increasing the efficiency of the difference calculation.

Following pre-optimizing, the byte-level differences are calculated between the new version and the modified original version, at block 306. The calculated differences are coded and merged, and the delta file is generated by following the pre-defined encoding format, at block 308. The delta file is then post-optimized to further reduce the file size, at block 310. The delta file is provided as an output, at block 312.

Calculation of the byte-level differences includes calculating edit distances between the compared files and generating an operation array, but is not so limited. The file differencing algorithm of an embodiment calculates the edit distances between the compared files and generates the operation array. The edit distance between two byte streams, as described by D. Gusfield in “Algorithms on Strings, Trees, and Sequences: Computer Science and Computational Biology,” (“the Gusfield reference”) Cambridge (1997), is the minimum number of edit operations needed to transform the original byte stream into the new byte stream. The edit operations of an embodiment include insertions, deletions and substitutions or replacements. The edit operations used to transform the original byte stream into the new byte stream are expressed with an operation array including the symbols “I” (one byte insertion), “D” (one byte deletion), “R” (one byte replacement), and “M” (one byte match). An example is now described.

For this example, the original byte stream is “vintner,” the new byte stream is “writers,” and the associated operation array generated during edit distance calculations is “RIMDMDMMI.” This operation is depicted as

| R | I | M | D | M | D | M | M | I |
|---|---|---|---|---|---|---|---|---|
| v | | i | n | t | n | e | r | |
| w | r | i | | t | | e | r | s. |

Applying the operation array to the original byte stream to generate the new byte stream begins with a replacement (R) of the first byte “v” of the original byte stream with a new byte “w” in the new byte stream. The second operation performed on the original byte stream is an insertion (I) of a new byte “r”. The third element of the operation array indicates a match (M), so the original byte “i” is copied in the new byte stream. The fourth operation is a deletion (D), resulting in the deletion of byte “n” in the new byte stream. The fifth operation indicates another match (M), so the original byte “t” is copied in the new byte stream. The sixth operation is another deletion (D), resulting in the deletion of byte “n” in the new byte stream. The seventh operation is another match (M), so the original byte “e” is copied into the new byte stream. The eighth operation is yet another match (M), so the original byte “r” is copied into the new byte stream. The ninth operation performed on the original byte stream is an insertion (I) of a new byte “s” into the new byte stream.

The file differencing algorithm that generates the operation array under an embodiment is based on two algorithms known in the art, but is not so limited. One of these algorithms is Hirschberg's linear-space optimal alignment algorithm, as described by D. S. Hirschberg in “A linear space algorithm for computing maximal common subsequences,” Comm. ACM 18,6 (1975) 341-343. The other algorithm is Ukkonen's linear-time suffix tree algorithm, as described by E. Ukkonen in “On-line construction of suffix trees,” (“the Ukkonen reference”) Algorithmica 14(3), 249-260(1995).

A structure of interest in the context of the file differencing algorithm of an embodiment is the longest repeated sub-string in a stream. More specifically, it is referred to herein as the longest common sub-string (LCS) between two given byte streams. For example, “abc” is the LCS between “axababcdij” and “abiabc”. A linear-time algorithm is described by Ukkonen for use in identifying the LCS between two given byte streams.

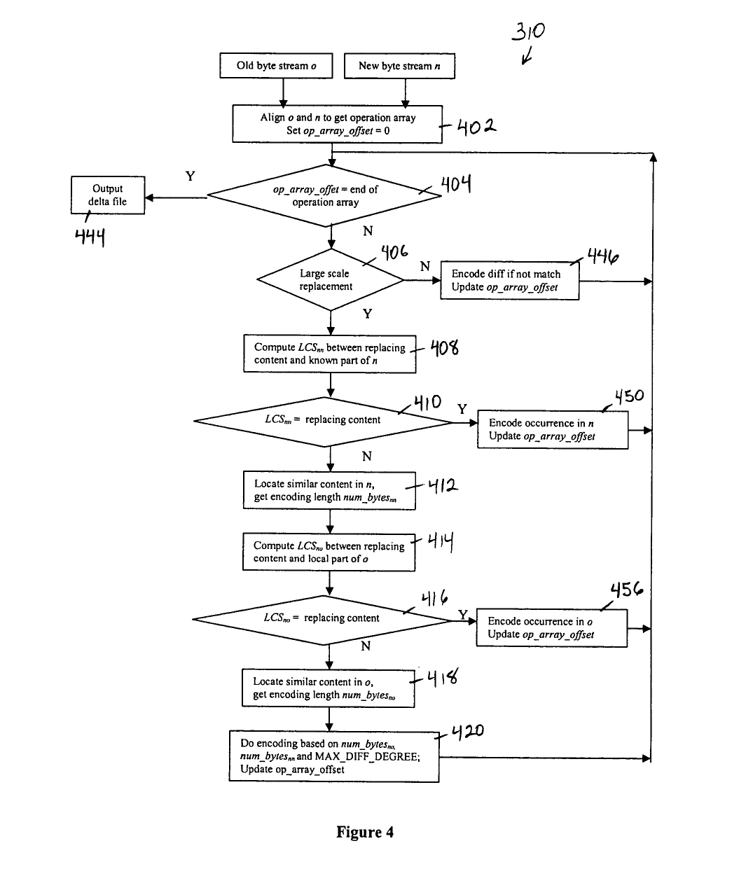

Following generation of the delta file, at least one post-optimizing routine is applied to reduce the size of the delta file, as described above. FIG. 4 is a flow diagram 310 for optimizing a delta file, under the embodiment of FIG. 2 and FIG. 3. As described above, post-optimizing operations are performed between the contents of the new version and the original version in order to identify common segments and simple patterns among contents of the two files. The knowledge of common segments and simple patterns is used to reduce/remove the differences among the versions required to be encoded in the delta file, thereby resulting in an overall performance gain.

The transmission of electronic file or software upgrades between a system and a client device can take a significant amount of time, especially when done via low bandwidth channels. An example is a cellular telephone software upgrade. It has become typical practice to send the byte-level file differences or changes between the new and original software versions over the cellular wireless couplings. The significant transfer time arises because the differences between the new and original versions of the executable files are more complex than the differences between their corresponding source files.

These complex differences between the new and original file versions arise in part because a small change in the source files often introduces major changes throughout the executable files. As an example, one type of change introduced in the executable files is a logical change that includes source code changes arising from source code line deletion from the original file, source code line addition to the new file, and source code line modifications. Logical changes occur, for example, when a programmer identifies a bug in a program and modifies the source file or code to eliminate the bug. The logical changes also include data initialization changes (e.g., the Internet Protocol (IP) address of a gateway server), resource and configuration file changes, and dictionary changes, but are not so limited.

Another type of introduced change is referred to herein as a secondary change. The secondary changes are defined to include, but not limited to, address changes, pointer target address changes, and changes in address offsets caused by address shifts resulting from the logical changes or code block swapping and generated by the software compiler/linker utilities. The pre-processing routines described below remove/reduce the secondary changes and encode information relating to the removal of these changes in information of the corresponding delta file.

Yet another type of introduced change includes byte-level code changes generated by the compiler/linker utilities not stemming from changes in the code logic or address shifts. For example, an instruction in the original version uses register R1, but the same instruction uses register R3 in the new version when, for example, register R1 is not available.

In identifying the differences between the original and the new files, the post-optimizing of an embodiment aligns byte streams or strings of each of the files, referred to herein as original byte streams and new byte streams. The alignment includes locating the largest common parts, for example the largest common sub-string (LCS), and then performing recursive alignments using the LCS. Some examples follow regarding alignment and matching of byte streams of the original and the new files.

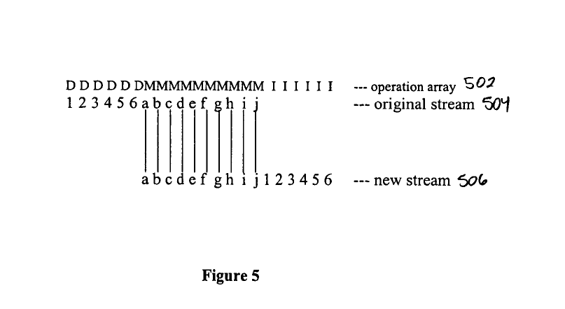

FIG. 5 is an example segment of an operation array 502 that codes information of a new file 506 as insertion of new data instead of movement of data of the original file 504, under an embodiment. The original file and the new file are also referred to herein as the original stream and the new stream. In this example, the original byte stream is “123456abcdefghij” and the new byte stream is “abcdefghij123456”. The largest common sub-string is identified as “abcdefghij”, and the original and new byte streams are aligned according to the LCS using the operation array as

DDDDDDMMMMMMMMMMIIIIII,

where the operation array is a sequence of ordered one-byte operations that encodes operations that support generation of the new byte stream from the old byte stream. Using this alignment, in the absence of post-optimizing, results in the sub-string “123456” being encoded as a six-byte deletion immediately preceding the LCS of the new byte stream and a six-byte insertion immediately following the LCS. As described below, the post-optimizing of an embodiment supports encoding this scenario as movement of a single sub-string of the original byte stream instead of a six-byte deletion from one area of the byte stream and a six-byte insertion into another area of the byte stream.

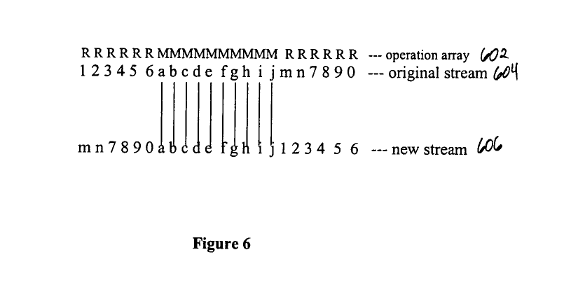

FIG. 6 is an example segment of an operation array 602 that codes information of a new file 606 as replacement of new data instead of exchanges of data among locations in the original file 604, under an embodiment. In this example, the original byte stream is “123456abcdefghijmn7890” and the new byte stream “mn7890abcdefghij123456”. The LCS is identified as “abcdefghij”, and the original and new byte streams are aligned according to the LCS using the operation array as

RRRRRRMMMMMMMMMMRRRRRR.

Using this alignment, in the absence of post-optimizing, results in the sub-strings “mn7890” and “123456” being encoded as two separate six-byte replacements immediately preceding and following the LCS of the new byte stream, respectively. As described below, the post-optimizing of an embodiment supports encoding this scenario as an exchange of two sub-strings of the original byte stream instead of two different six-byte replacements in two different areas of the new byte stream.

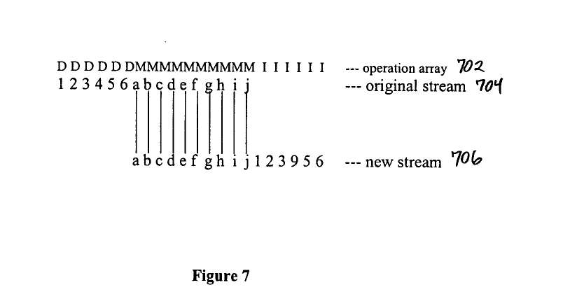

FIG. 7 is an example segment of an operation array 702 that codes information of a new file 706 as insertion of new data instead of movement of data of the original file 704 followed by a replacement of data, under an embodiment. In this example, the original byte stream is “123456abcdefghij” and the new byte stream is “abcdefghijl23956”. The largest common sub-string is identified as “abcdefghij”, and the original and new byte streams are aligned according to the LCS using the operation array as

DDDDDDMMMMMMMMMMIIIIII.

Using this alignment, in the absence of post-optimizing, results in the sub-string “123956” being encoded as a six-byte insertion immediately following the LCS of the new byte stream. As described below, the post-optimizing of an embodiment supports encoding this scenario as movement of the sub-string “123456” of the original byte stream followed by a single-byte replacement of the “4” with a “9”, instead of a six-byte insertion.

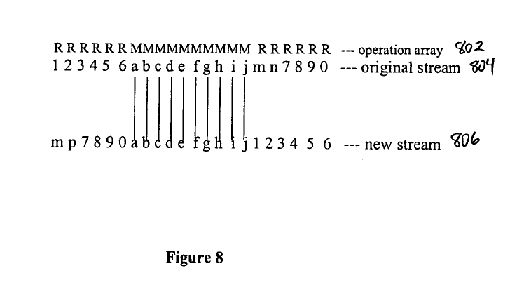

FIG. 8 is an example segment of an operation array 802 that codes information of a new file 806 as replacement of new data instead of exchanges of data among locations in the original file 804 followed by a replacement of data, under an embodiment. In this example, the original byte stream is “123456abcdefghijmn7890” and the new byte stream “mp7890abcdefghijl23456”. The LCS is identified as “abcdefghij”, and the original and new byte streams are aligned according to the LCS using the operation array as

RRRRRRMMMMMMMMMMRRRRRR.

Using this alignment, in the absence of post-optimizing, results in the sub-strings “mp7890” and “123456” being encoded as two separate six-byte replacements immediately preceding and following the LCS of the new byte stream, respectively. As described below, the post-optimizing of an embodiment supports encoding this scenario as an exchange of sub-strings of the original byte stream followed by a single-byte replacement of the “n” with a “p”, instead of two different six-byte replacements in two different areas of the new byte stream.

The scenarios described with reference to FIGS. 5-8 occur frequently because of the changes introduced in the executable files resulting from changes in the source files. However, the post-optimizing routine described herein, and with reference to FIG. 4, reduces the size of the delta file by improving the efficiency of the string alignment, thereby allowing for the identification and encoding of swap and re-order operations. As such, the optimization algorithm identifies similarities in replacement content of the new byte stream and already known segments of the new byte stream, or between the replacement content and a local area of the original byte stream. The post-optimizing algorithm, which is called during the post-processing stage of alignment-based file differencing algorithms, uses the LCS as a heuristic indicator in identifying the similarities, but is not so limited.

For simplicity in describing the post-optimizing algorithm, and because insertion can be regarded as the replacement of an empty sub-string (sub-string of zero bytes) with the new or replacement content, use of the term “replacement” below includes insertion, equal length replacement, and variable length replacement operations. The variable length replacement operations include those operations for which the length of a replaced sub-string is different than the length of the replacing sub-string (for example, a ten-byte insertion includes a replacement operation wherein the length of the replacing sub-string is ten bytes and the length of the sub-string being replaced is zero bytes).

The post-optimizing algorithm of an embodiment makes use of two assumptions. A first assumption involves the concept that most file change patterns swap/change the order of sub-strings of a byte stream within a limited region or section of the byte stream. Consequently, if a particular byte sub-string is identified to be the replacement content in the new byte stream based on an alignment of the original and the new byte streams, there is a high probability that an identical or similar byte sub-string can be found in the original byte stream near the region of the current replacement operation.

A second assumption makes use of the principle of locality of reference to assume that when byte sub-strings are identified as replacement content based on an alignment of the original and new byte streams, there is high probability that an identical or similar byte sub-string can be found in the new byte stream preceding the region of the current replacement operation. One example relating to this second assumption is that the padding bytes of embedded software files are generally the same, where the padding bytes are bytes (e.g., 1×FF, 0×00) filled into an unused area of a software image (for example, the reserved area between neighboring software modules). Another example is the placing of related topics adjacent to one another when forming a word document.

In describing the post-optimizing algorithm below, a number of functions are referenced. These functions include “length(s)”, “min(a, b)”, “max(a, b)”, “align(s, t, op_array)”, and “lcs(s, t)”. The function length(s) represents the length of string s. The function min(a, b) represents the minimum of a and b. The function max(a, b) represents the maximum of a and b.

Continuing, the function align(s, t, op_array) is a function that aligns string s and string t using op_array as the operation array that controls the alignment. One example of this function is the associated file differencing algorithm of the file differencing engine (for example, file differencing algorithm GETDIFF(s, t, op_array) described in the Related Applications).

The function lcs(s, t) is a function that computes the LCS between two byte strings s and t. One example of this function is the Ukkonen Algorithm referenced above.

Along with the functions, a number of pre-defined configurable parameters are used in the post-optimizing algorithm. These pre-defined configurable parameters include MIN_COMPARE_BYTES, MAX_SEARCH_LENGTH, MAX_SEARCH_RADIUS, and MAX_DIFF_DEGREE. The MIN_COMPARE_BYTES parameter specifies the minimum length of replacement content that produces a processing advantage when used in a search for similar content in the original byte stream or the already known portion of the new byte stream. This parameter can be set to 16, for example, but is not so limited. Setting this parameter too low can result in processing overhead that offsets the gains of post-processing.

Continuing, the MAX_SEARCH_LENGTH parameter specifies the maximum content comparison area in the new byte stream preceding the replacement content. This parameter can be set to 1 mega-byte (MB), for example, but is not so limited.

The MAX_SEARCH_RADIUS parameter specifies the maximum content comparison area in the original byte stream. This parameter can be set to 1 MB, for example, but is not so limited.

The MAX_DIFF_DEGREE parameter specifies the degree of content similarity. A smaller parameter indicates more similarity between compared contents. This parameter can be set to 0.6, for example, but is not so limited.

As presented above, FIG. 4 is a flow diagram 310 for post-optimizing a delta file, under the embodiment of FIG. 2 and FIG. 3. Operation according to the flow diagram 310 begins when the post optimizer receives the original/old byte stream o and new byte stream n as inputs. The post-optimizer calls the function align(o, n, op array) in order to get the operation array (op_array) for aligning o and n, at block 402; further, the post-optimizer sets the current operation array offset equal to zero (op_array_offet=0). A determination is made whether the operation array offset is equal to the end of the operation array, at block 404. When the operation array offset indicates the end of the operation array, the post-optimizer outputs the delta file, at block 444.

When the operation array offset indicates that post-optimization processing has not reached the end of the operation array, at block 404, operation continues by determining whether the length of the replacement content (length(nᵣ)) is equal to or greater than the parameter MIN_COMPARE_BYTES, at block 406. When the length of the replacement content is less than the parameter MIN_COMPARE_BYTES, at block 406, the current operation is encoded into the delta file when the current operation is not a match operation (M), at block 446, and the operation array offset value is updated or adjusted as appropriate. Operation then returns to block 404 and proceeds as described above.

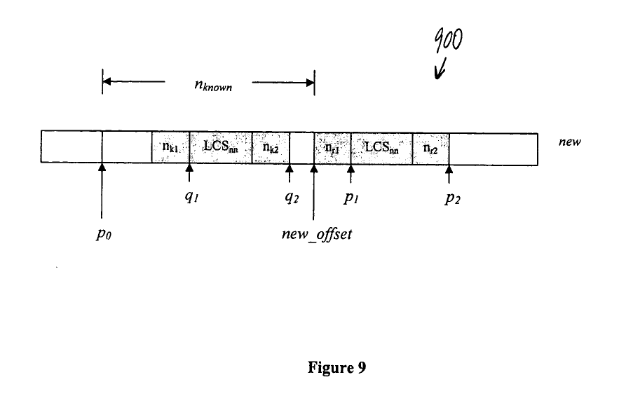

When the length of the replacement content sub-string is equal to or greater than the parameter MIN_COMPARE_BYTES, at block 406, operation proceeds to begin a large scale replacement operation, at block 408. The large scale replacement operation begins with the post-optimizer recording a number of parameters including, but not limited to, the old_offset, the new_offset, which are the current locations of o and n where this portion of the operation starts. The post-optimizer then calls the function lcs(nᵣ, n_{known}) to identify the LCS between the sub-strings nᵣ and n_{known}, at block 408, where n_{known} is described below with reference to FIG. 9. The identified LCS is denoted LCSₙₙ, and the starting points of LCSₙₙ on the new byte stream n are denoted q₁ and p₁. If the length of the identified LCSₙₙ (length(LCSₙₙ)) is equal to the length of the replacement content nᵣ (length(nᵣ)), at block 410, information of the identified LCSₙₙ is encoded into the delta file, at block 450. The operation array offset op_array_offset is also updated, and operation returns to block 404 and proceeds as described above.

If the length of the identified LCSₙₙ as determined by length(LCSₙₙ) is not equal to the length of the replacement content nᵣ (length(nᵣ)), at block 410, operation continues in order to identify similar content in the new byte stream n, at block 412. Identification of similar content in the new byte stream n begins with the post-optimizer calling the function align(nₖ₁, nᵣ₁, op_arrayₙₙ) to align the sub-strings nₖ₁ and nᵣ₁.

FIG. 9 is a block diagram 900 for use in identifying content similarity between replacement content nᵣ and known content n_{known} of the new byte stream n, under the embodiment of FIG. 4. Referring to the new byte stream n, the following variables are defined:
p₀=max(0, new_offset−MAX_SEARCH_LENGTH);
p₂=new_offset+length(nᵣ);
nᵣ₁=sub-string from new_offset to p₁−1;
nᵣ₂=sub-string from p₁+length(LCSₙₙ) to p₂−1;
q₂=min(new_offset, q₁+length(LCSₙₙ)+length(nᵣ₂));
nₖ₁=sub-string from max(p₀, q₁−length(nᵣ₁)) to q₂−1;
nₖ₂=sub-string from q₁+length(LCSₙₙ) to q₂−1;
op_arrayₙₙ=operation array for aligning nₖ₁+LCSₙₙ+nₖ₂ and nᵣ.
   Further, the variable nᵣ represents the replacement content starting at the new_offset according to the alignment (block 402). The sub-string of the new byte stream n from p₀ to the location (new_offset−1) is represented as n_{known} because this sub-string is already known by the updating engine when processing reaches this location.

Following alignment of the sub-strings nₖ₁ and nᵣ₁, the post-optimizer writes matches M to the operation array op_arrayₙₙ, and M is written length(LCSₙₙ) times. The post-optimizer then calls the function align(nₖ₂, nᵣ₂, op_arrayₙₙ) to align the sub-strings nₖ₂ and nᵣ₂. The post-optimizer next encodes the edit distance between the byte string (nₖ₁+LCSₙₙ+nₖ₂) and the replacement content string nᵣ, according to op_arrayₙₙ, where num_bytesₙₙ is the number of bytes used in the encoding, at block 412.

The large scale replacement operation continues when the post-optimizer calls the function lcs(nᵣ, o_{local}) to identify the LCS between the replacement content nᵣ and sub-string o_{local}, at block 414, where o_{local} represents a sub-string of the original byte stream between points t₀ and t₁, where
t₀=max(0, old_offset−MAX_SEARCH_RADIUS), and
t₁=min(length(o)−1, old_offset+MAX_SEARCH_RADIUS).
   The identified LCS is denoted LCSₙₒ, and the starting points of LCSₙₒ on the original o and new n byte streams are denoted q₁′ and p₁′, respectively. If the length of the identified LCSₙₒ (length(LCSₙₙ)) is equal to the length of the replacement content nᵣ (length(nᵣ)), at block 416, information of the identified LCSₙₒ is encoded into the delta file, at block 456. The operation array offset op_array_offset is also updated, and operation returns to block 404 as described above.

If the length of the identified LCSₙₒ as determined by length(LCSₙₒ) is not equal to the length of the replacement content nᵣ (length(nᵣ)), at block 416, operation continues in order to identify similar content in the original byte stream o, at block 418. Identification of similar content in the original byte stream o begins with the post-optimizer calling the function align(o₁, nᵣ₁, op_arrayₙₒ) to align the sub-strings o₁ and nᵣ₁.

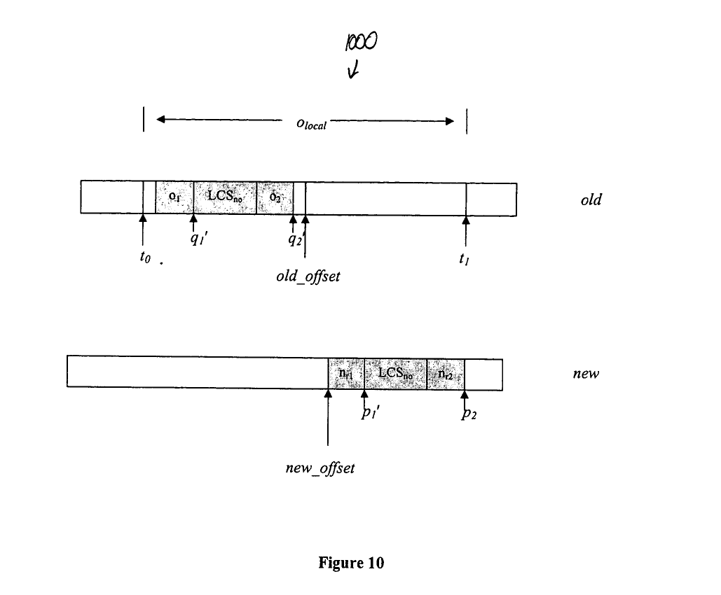

FIG. 10 is a block diagram 1000 for use in identifying content similarity between replacement content nᵣ of a new byte stream n and local content o_{local} of a corresponding original byte stream o, under the embodiment of FIG. 4. Referring to the block diagram 1000, the following variables are defined:
nᵣ₁=sub-string from new_offset to p₁′−1;
nᵣ₂=sub-string from p₁′+length(LCSₙₒ) to p₂−1;
q₂′=min(t₁, q₁′+length(LCSₙₒ)+length(nᵣ₂));
o₁=sub-string from max(to, q₁′−length(nᵣ₁)) to q₁′−1;
o₂=sub-string from q₁′+length(LCSₙₒ) to q₂′−1;
op_arrayₙₒ=operation array for aligning o₁+LCSₙₙ+o₂ and nᵣ.

Following alignment of the sub-strings o₁ and nᵣ₁, the post-optimizer writes matches M to the operation array op_arrayₙₒ, and M is written length(LCSₙₒ) times. The post-optimizer then calls the function align(o₂, nᵣ₂, op_arrayₙₒ) to align the sub-strings o₂and nᵣ₂. The post-optimizer next encodes the edit distance between the byte string (o₁+LCSₙₒ+o₂) and the replacement content string nᵣ, according to op_arrayₙₒ, where num_bytesₙₒ is the number of bytes used in the encoding, at block 418.

The post-optimizer next encodes information to the delta file based on num_bytesₙₒ, num_bytesₙₙ, and the parameter MAX_DIFF_DEGREE, at block 420. In an embodiment, when num_bytesₙₒ is less than or equal to num_bytesₙₙ, and (num_bytesₙₒ/length(nᵣ)) is less than MAX_DIFF_DEGREE, the post-optimizer encodes information that similar content is found in the original byte stream o. The operation array offset op_array_offset is also updated, and operation returns to block 404 as described above.

When num_bytesₙₙ is less than or equal to num_bytesₙₒ, and (num_bytesₙₙ/length(nᵣ)) is less than MAX_DIFF_DEGREE, at block 420, the post-optimizer encodes information that similar content is found in the new byte stream n. The operation array offset op_array_offset is also updated, and operation returns to block 404 as described above.

As an example of a device and/or system using the post-processing described above, the computing devices receiving and using the delta file may be client devices that host corresponding software applications in need of updating, for example cellular telephones, mobile electronic devices, mobile communication devices, personal digital assistants, and other processor-based devices. This support is provided for all mobile device software ranging from firmware to embedded applications by enabling carriers and device manufacturers to efficiently distribute electronic file content and applications via their wireless infrastructure.

Another example of systems that benefit from the post-processing described above includes systems using wired serial connections to transfer the delta file from a device hosting the file differencing engine to a device hosting the file updating engine. These systems typically have slow transfer rates and, because the transfer rates are slow, a reduction in the size of the delta file is a way to realize faster transfer times.

Yet another example of systems that benefit from use of the post-processing includes wireless systems using radio communications to transfer the delta file from a device hosting the file differencing engine to a device hosting the file updating engine. While suffering from low reliability associated with the wireless connections, these systems also have slow transfer rates. The use of a smaller delta file in these systems provides several advantages. For example, the smaller file size results in a faster delta file transfer time. The faster transfer time, while saving time for the device user, reduces the opportunity for the introduction of errors into the delta file, thereby increasing system reliability. Also, with cellular communications, the reduced transfer time results in a cost savings for the consumer who is typically charged by the minute for service.

As another advantage, the smaller delta file reduces the bandwidth required to transfer the delta files to client devices. The reduced bandwidth allows for the support of more client devices via the allocated channels. As with the reduced transfer time, this too results in a reduction in operating costs for the wireless service provider.

Aspects of the invention may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the invention include: microcontrollers with memory (such as electronically erasable programmable read only memory (EEPROM)), embedded microprocessors, firmware, software, etc. Furthermore, aspects of the invention may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, shall refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the invention is not intended to be exhaustive or to limit the invention to the precise form disclosed. While specific embodiments of, and examples for, the invention are described herein for illustrative purposes, various equivalent modifications are possible within the scope of the invention, as those skilled in the relevant art will recognize. The teachings of the invention provided herein can be applied to other processing systems and communication systems, not only for the file differencing systems described above.

The elements and acts of the various embodiments described above can be combined to provide further embodiments. These and other changes can be made to the invention in light of the above detailed description.

All of the above references and United States patents and patent applications are incorporated herein by reference. Aspects of the invention can be modified, if necessary, to employ the systems, functions and concepts of the various patents and applications described above to provide yet further embodiments of the invention.

In general, in the following claims, the terms used should not be construed to limit the invention to the specific embodiments disclosed in the specification and the claims, but should be construed to include all processing systems that operate under the claims to provide file differencing. Accordingly, the invention is not limited by the disclosure, but instead the scope of the invention is to be determined entirely by the claims.

While certain aspects of the invention are presented below in certain claim forms, the inventors contemplate the various aspects of the invention in any number of claim forms. For example, while only one aspect of the invention is recited as embodied in computer-readable medium, other aspects may likewise be embodied in computer-readable medium. Accordingly, the inventors reserve the right to add additional claims after filing the application to pursue such additional claim forms for other aspects of the invention.

1. An apparatus comprising an optimizing system that generates difference files between an original byte stream and a new byte stream by identifying replacement content in a first area of the new byte stream, wherein the replacement content includes a group of bytes of the new byte streams identified as at least one of byte insertions and byte replacements in an operation array, identifying content similarities between the replacement content and at least one of the original byte stream and a second area of the new byte stream, and encoding information of the content similarities to the difference file.

2. An apparatus for generating difference files, comprising:
means for receiving an original byte stream that is a segment of an original file and a new byte stream that is a segment of a new file, wherein the new file includes an updated version of the original file;
means for identifying replacement content of the new byte stream, wherein replacement content includes a group of bytes of the new byte stream identified as at least one of byte insertions and byte replacements in an operation array;
means for comparing the replacement content and portions of the new byte stream and identifying a first set of content similarities resulting from the comparison;
means for comparing the replacement content and portions of the original byte stream and identifying a second set of content similarities resulting from the comparison; and
means for generating the difference file by encoding information of the first set and second set of content similarities.

3. The apparatus of claim 2, further comprising means for transferring the difference file to a remote system that hosts a copy of the original file, the remote system updating the hosted copy of the original file using the difference file.

4. A method for generating difference files, comprising:
receiving an original byte stream that is a segment of an original file and a new byte stream that is a segment of a new file, wherein the new file includes an updated version of the original file;
identifying replacement content of the new byte stream, wherein replacement content includes a group of bytes of the new byte stream identified as at least one of byte insertions and byte replacements in an operation array;
comparing the replacement content and portions of the new byte stream and identifying a first set of content similarities resulting from the comparison;
comparing the replacement content and portions of the original byte stream and identifying a second set of content similarities resulting from the comparison; and
generating the difference file by encoding information of the first set and second set of content similarities.

5. The method of claim 4, wherein comparing the replacement content with portions of the new byte stream further includes:
identifying at least one first largest common sub-string (LCS) of bytes in response to the comparison; and
identifying the first set of content similarities between the replacement content and the new byte stream using the first LCS.

6. The method of claim 4, wherein comparing the replacement content with portions of the original byte stream further includes:
identifying at least one second LCS in response to the comparison; and
identifying the second set of content similarities between the replacement content and the original byte stream using the second LCS.

7. The method of claim 4, further comprising:
encoding a first edit distance between the replacement content and portions of the new byte stream; and
encoding a second edit distance between the replacement content and portions of the original byte stream.

8. The method of claim 7, wherein generating the difference file further includes comparing information including at least one of a number of bytes used to encode the first edit distance, a number of bytes used to encode the second edit distance, a number of bytes of the replacement content, and a degree of content similarity.

9. The method of claim 4, wherein generating the difference file by encoding information of the first set of content similarities further comprises:
encoding a first edit distance between the replacement content and portions of the new byte stream and encoding a second edit distance between the replacement content and portions of the original byte stream;
comparing a number of bytes used to encode the first edit distance to a number of bytes used to encode the second edit distance;
comparing the number of bytes used to encode the first edit distance to a length of the replacement content and a degree of content similarity; and
encoding information of the first set of content similarities when the number of bytes used to encode the first edit distance is less than or equal to the number of bytes used to encode the second edit distance and a quantity formed by dividing the number of bytes used to encode the first edit distance by the length of the replacement content is less than the degree of content similarity.

10. The method of claim 4, wherein generating the difference file by encoding information of the second set of content similarities further comprises:
encoding a first edit distance between the replacement content and portions of the new byte stream and encoding a second edit distance between the replacement content and portions of the original byte stream;
comparing a number of bytes used to encode the second edit distance to a number of bytes used to encode the first edit distance;
comparing the number of bytes used to encode the second edit distance to a length of the replacement content and a degree of content similarity; and
encoding information of the second set of content similarities when the number of bytes used to encode the second edit distance is less than or equal to the number of bytes used to encode the first edit distance and a quantity formed by dividing the number of bytes used to encode the second edit distance by the length of the replacement content is less than the degree of content similarity.

11. A system for updating electronic files of remote devices, comprising:
a first device including a file differencing engine that generates differences between an original version and a new version of an electronic file by:
receiving an original byte stream that is a segment of the original version and a new byte stream that is a segment of the new version;
identifying replacement content of the new byte stream, wherein replacement content includes a group of bytes of the new byte stream identified as at least one of byte insertions and byte replacements in an operation array;
comparing the replacement content and portions of the new byte stream and identifying a first set of content similarities resulting from the comparison;
comparing the replacement content and portions of the original byte stream and identifying a second set of content similarities resulting from the comparison;
generating a difference file including encoded information of the first set and second set of content similarities; and
a file updating engine hosted on the remote devices, the file updating engine generating a copy of the new version using the difference file.

12. The system of claim 11, wherein the remote device includes at least one of cellular telephones, portable communication devices, personal digital assistants, personal computers, and portable processor-based devices.

13. A computer readable medium including executable instructions which, when executed in a processing system, reduce a size of a difference file that includes coded differences between an original version and a new version of an electronic file by:
identifying replacement content of a new byte stream that is a segment of the new version, wherein replacement content includes a group of bytes of the new byte stream identified as at least one of byte insertions and byte replacements in an operation array;
comparing the replacement content and portions of the new byte stream and identifying a first set of content similarities resulting from the comparison;
comparing the replacement content and portions of an original byte stream and identifying a second set of content similarities resulting from the comparison, wherein the original byte stream is a segment of the original version; and
generating the difference file by encoding information of the first set and second set of content similarities.
